(19) United States
(12) Patent Application Publication
(10) Pub. No.: US 2011/0176477 A1
(43) Pub. Date: Jul. 21, 2011

(54) COOPERATIVE COMMUNICATION METHOD AND BASE STATION THEREOF

(75) Inventors: Kyoungseok Lee, Daejon (KR); Jae-Young Ahn, Daejon (KR); Yeongjin Kim, Daejon (KR)

(73) Assignee: ELECTRONICS AND TELECOMMUNICATIONS RESEARCH INSTITUTE, Daejon (KR)

(21) Appl. No.: 13/120,797

(22) PCT Filed: Sep. 22, 2009
(86) PCT No.: PCT/KR2009/005396

§ 371 Date: Mar. 24, 2011

(30) Foreign Application Priority Data
Sep. 25, 2008 (KR) 10-2008-0094192
Mar. 4, 2009 (KR) 10-2009-0018414
Jun. 23, 2009 (KR) 10-2009-0055829

(51) Int. Cl. H04B 7/14; H04W 72/04; H04W 36/00

(52) U.S. Cl. 370/315; 370/329; 370/332

(57) ABSTRACT

A cooperative communication method for cooperative communication with a user equipment by using a plurality of cells and a base station used for the cooperative communication are disclosed. The method for performing a cooperative communication for a user equipment by using a plurality of cells includes: comparing channel state information for a radio signal with a predetermined threshold value to thereby produce a comparison result; determining whether to perform the cooperative communication for the user equipment based on the comparison result; and transmitting a control message for cooperative communication to a cooperating cell which is to perform the cooperative communication.

### TECHNICAL FIELD

The present invention relates to a cooperative communication method and a base station thereof; and, more particularly, to a cooperative communication method for cooperative communication with a user equipment by using a plurality of cells and a base station used for the cooperative communication.

### BACKGROUND ART

The 3rd Generation Partnership Project (3GPP), which is an organization for mobile telecommunication standardization, is working on a Long Term Evolution (LTE) standardization activity to develop a next-generation mobile communication system specification. The 3GPP is also developing LTE Advanced specification which supplements LTE specification in order to fulfill the IMT-advanced requirements suggested by International Telecommunication Unit Radio communication sector (ITU-R).

The next-generation mobile communication system uses an Orthogonal Frequency Division Multiple Access (OFDMA) in the downlink and uses OFDMA or Single Carrier Frequency Division Multiple Access (SC-FDMA) in the uplink.

A typical mobile communication system includes evolved Nodes B (eNBs), which are base stations, and user equipments. Each evolved Node B forms a cell and the user equipment is used by a user. A plurality of user equipments transmit/receive data to/from an evolved Node B through a radio channel. Also, in order to widen the communication coverage of the evolved Node B and enhance the communication capacity, the evolved Node B is connected to a relay station and the relay station wirelessly relays the communication between a user equipment and the evolved Node B. The relay station wirelessly receives data to be transmitted to the user equipment from the evolved Node B and relays the data to the user equipment and transmits data received from the user equipment to the evolved Node B.

FIG. 1 illustrates a general packet-based mobile communication system using relay stations. In the example shown in FIG. 1, a plurality of evolved Nodes B 101 and a plurality of relay stations 102 are shown.

Generally, an evolved Node B and a user equipment transmit/receive data and control information through a radio channel. The user equipment can perform communication when it is positioned within the communication coverage of the evolved Node B, and a relay station 102 is used to expand the communication coverage.

The relay station 102 is a node that is wirelessly linked to the evolved Node B 101, relays data received through a radio channel to the user equipment, and receives radio signals from the user equipment to transmit them to the evolved Nodes B 101. Accordingly, the user equipment positioned within the communication coverage of the relay station 102 performs radio communication with the relay station 102, and the relay station 102 wirelessly relays what was communicated with the user equipment to the evolved Nodes B 101. Also, the relay station 102 communicates with another relay station 102 wirelessly or through cable.

To help understand the present invention, radio channels related to data transmission used in the next-generation mobile communication system will be briefly described hereafter.

Physical Downlink Control Channel (PDCCH) is a physical channel for transmitting control signals needed for receiving and demodulating data to a user equipment. The physical downlink control channel includes control signals needed for receiving Physical Downlink Shared Channel (PDSCH) and control signals relating to transmission of Physical Uplink Shared Channel (PUSCH). The physical downlink shared channel (PDSCH) is a physical channel for transmitting downlink data, and it is referred to as a downlink data channel.

Physical Uplink Control Channel (PUCCH) is a physical channel for transmitting control signals from a user equipment to an evolved Node B. Physical uplink shared channel (PUSCH) is a physical channel for transmitting uplink data and it is referred to as an uplink data channel.

In a mobile communication system, a user equipment positioned in the cell boundary where the intensity of radio signals are weak has a problem of deteriorated communication performance. In particular, when a relay station is used to communicate with the user equipment positioned in the cell boundary where the intensity of radio signals are weak, there is a problem in that a user equipment positioned in the boundary between the evolved Node B and the relay station has lower transmission/reception performance than a user equipment positioned at the center of a cell. Therefore, it is required to improve the performance of the user equipment positioned in the boundary. Herein, the relay station functions as an evolved Node B in the aspect of cell configuration to thereby expand the communication coverage and capacity. Also, since the next-generation mobile communication system uses high frequency domain and an OFDM communication scheme whose communication performance is considerably deteriorated in the cell boundary, there is a problem of drastic decline in the communication performance in the cell boundary.

### DISCLOSURE OF INVENTION

### Technical Problem

An embodiment of the present invention devised to overcome the problems of conventional technology is directed to providing a cooperative communication method that can improve the utility efficiency of radio resources and expand a communication coverage in a mobile communication system, and an evolved Node B executing a cooperative communication.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Solution to Problem

In accordance with an aspect of the present invention, there is provided a method for performing a cooperative communication for a user equipment by using a plurality of cells, which includes: comparing channel state information for a radio signal with a predetermined threshold value to thereby produce a comparison result; determining whether to perform the cooperative communication for the user equipment based on the comparison result; and transmitting a control message for cooperative communication to a cooperating cell which is to perform the cooperative communication.

In accordance with another aspect of the present invention, there is provided an evolved Node B for performing a cooperative communication for a user equipment by using a plurality of cells, which includes: a controller configured to compare channel state information for a radio signal with a predetermined threshold value to thereby produce a comparison result and determine whether to perform the cooperative communication for the user equipment based on the comparison result; and a transmitter configured to transmit a control message for cooperative communication to a cooperating cell which is to perform the cooperative communication.

### Advantageous Effects of Invention

The technology of the present invention may improve the communication performance of a user equipment positioned in the cell boundary.

### BRIEF DESCRIPTION OF DRAWINGS

FIG. 1 illustrates a configuration of a general packet-based mobile communication system using relay stations.

FIG. 2 is a flowchart describing a cooperative communication method in accordance with an embodiment of the present invention.

FIG. 3 is a block view illustrating an evolved Node B performing a cooperative communication in accordance with an embodiment of the present invention.

FIG. 4 illustrates how a downlink cooperative communication is established in accordance with an embodiment of the present invention.

FIG. 5 illustrates how an uplink cooperative communication is established in accordance with an embodiment of the present invention.

FIG. 6 illustrates a process of performing a downlink cooperative communication by using a plurality of relay stations in accordance with an embodiment of the present invention.

FIG. 7 illustrates a process of performing an uplink cooperative communication by using a plurality of relay stations in accordance with an embodiment of the present invention.

FIG. 8 illustrates a process of performing a cooperative communication by using a plurality of relay stations belonging to different evolved Nodes B in accordance with an embodiment of the present invention.

FIG. 9 illustrates a synchronization process between an evolved Node B and a relay station in accordance with an embodiment of the present invention.

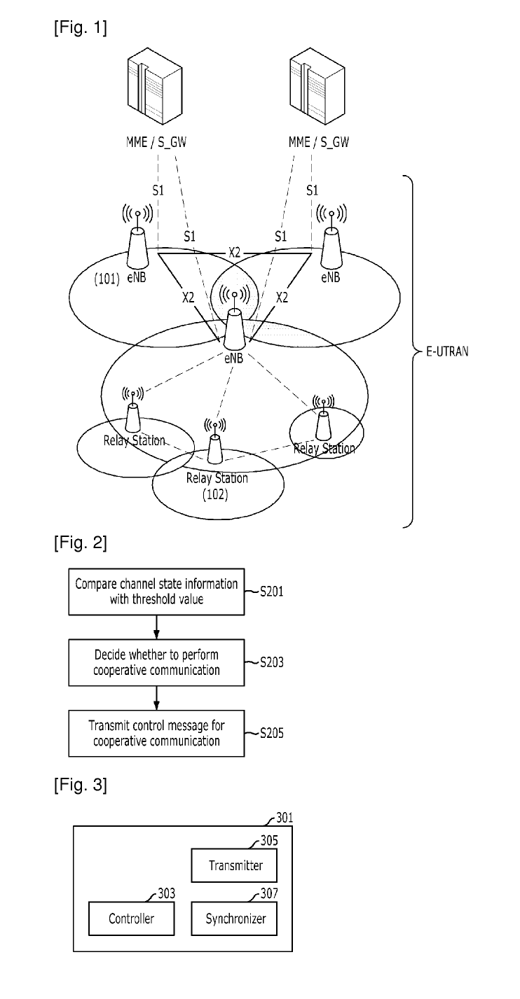

### BEST MODE FOR CARRYING OUT THE INVENTION

The advantages, features and aspects of the invention will become apparent from the following description of the embodiments with reference to the accompanying drawings, which is set forth hereinafter. Also, when it is considered that detailed description on the prior art may obscure a point of the present invention, the description will not be provided in this specification. Hereafter, specific embodiments of the present invention will be described with reference to the accompanying drawings.

Following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

Also, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of diverse devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as combinations of circuits for performing the intended function, firmware/microcode and the like.

To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

FIG. 2 is a flowchart describing a cooperative communication method in accordance with an embodiment of the present invention. The present invention relates to a cooperative communication with a user equipment by using a plurality of cells. In step S201, channel state information for radio signals is compared with a predetermined threshold value. In step S203, whether to perform a cooperative communication for the user equipment or not is determined based on the comparison result. As for a user equipment positioned within the cell coverage and has fine channel state for radio signals, the cooperative communication may not be performed. The cooperative communication is performed for a user equipment which is positioned in the cell boundary and the channel condition for radio signals is fine.

A cell includes an evolved Node B or a relay station and it means a predetermined region in which data are transmitted/received with respect to a user equipment. Herein, the relay station performs the same function as the evolved Node B in a mobile communication cell and it may relay data transmitted and received between an evolved Node B and a user equipment.

Cooperative communication is to transmit/receive data to/from a user equipment by using a plurality of cells. The cooperative communication may be performed when the user equipment is positioned in the boundary of multiple cells. For example, when a user equipment is positioned in an intersection region of a first cell and a second cell, the cooperative communication may be performed. The cooperative communication may be performed for the same data but it is not limited to it. For instance, it is also possible that a plurality of cells transmit different data to a user equipment and the user equipment may collect and combine the different data transmitted from the multiple cells.

A plurality of cells performing a cooperative communication may have a relationship of evolved Node B-and-evolved Node B, a relationship of evolved Node B-and-relay station, or a relationship of relay station-and-relay station. An evolved Node B or a relay station with the most excellent state for radio signals may take charge of controlling the user equipment.

To describe the relationship between an evolved Node B and a relay station with an example, in a case of downlink, the evolved Node B selects and transmits radio resources for transmitting data inputted from a network to the evolved Node B and radio resources for transmitting the data from the evolved Node B to the relay station. Radio resources for transmitting the data from the relay station to a user equipment may be selected in the relay station under the management of the evolved Node B and transmitted to the user equipment. The evolved Node B may transmit the data directly to the user equipment or through the relay station, and the transmission route is up to a decision of the evolved Node B. In a case of uplink, the evolved Node B selects radio resources for transmitting uplink data from the user equipment to the evolved Node B and radio resources for transmitting the data from the relay station to the evolved Node B, and transmits them to the user equipment and the relay station. The user equipment and the relay station transmit the uplink data to the evolved Node B based on the radio resource information. Uplink radio resources for transmitting the data from the user equipment to the relay station are selected in the relay station and transmitted to the user equipment. The data transmitted from the user equipment may be directly received by the evolved Node B or relayed to the evolved Node B by the relay station.

Whether to perform a cooperative communication or not is determined by measuring the channel state for radio signals to thereby produce a measurement value and comparing the measurement value with a predetermined threshold value. Herein, the channel state information for radio signals includes information that may be used to determine transmission/reception state of radio signals, e.g., information on the signal intensity of transmission/reception signals between the user equipment and a corresponding cell. The signal intensity information corresponds to information for determining transmission/reception state of radio signals according to range or fading.

Herein, the signal intensity may be a signal intensity of a signal transmitted from the evolved Node B or the relay station to the user equipment and measured by the user equipment, or it may be a signal intensity of a signal transmitted from the user equipment to the evolved Node B or the relay station and measured by the evolved Node B or the relay station. The former case corresponds to downlink whereas the latter case corresponds to uplink. In the case of downlink, the user equipment receives a signal and measures its signal intensity. If the signal intensity of a signal transmitted from a serving cell and measured by the user equipment is lower than the predetermined threshold value and the signal intensity of a signal transmitted from a cooperating cell is higher than the predetermined threshold value, the evolved Node B initiates a cooperative communication with the user equipment.

It is desirable to consider handover operation to determine whether to initiate the cooperative communication or not. The collision between the handover operation and the cooperative communication operation may be prevented by comparing the measured signal intensity with a handover threshold value. For example, since the signal intensity threshold value for a serving cell, which is used for setting up a cooperative communication is higher than a signal intensity threshold value used for determining a handover operation, the cooperative communication begins when the signal intensity of a signal transmitted from the serving cell in which the user equipment is registered is higher than the signal intensity threshold value for handover operation.

Also, the standards for determining whether to perform a cooperative communication include quality of service (QoS) information of a communication service, time delay threshold value information of the communication service, and information on the reception time difference of the user equipment for a signal transmitted from a cooperating cell. These standards will be described in detail, hereafter.

The QoS information of a communication service may be used as a standard for determining whether to perform a cooperative communication or not. When a communication service provided from the cooperative communication requires a fine channel state, a cooperative communication threshold value related to signal intensity for determining to perform a cooperative communication is set up high.

Also, time delay threshold value information of the communication service may be used as a standard for determining whether to perform a cooperative communication or not. When a real-time service is needed and time delay should be small, a time delay threshold value required by the communication service is used to determine whether to perform a cooperative communication or not. For example, when the quality of the real-time service is affected by data relaying time, which is needed for cooperative communication, it is determined not to perform a cooperative communication.

In addition, information on the reception time difference of the user equipment for signals transmitted from a cooperating cell may be used as a standard for determining whether to perform a cooperative communication or not. In other words, time information may be used as a threshold value for determining whether to perform a cooperative communication. The user equipment receives a downlink radio signal transmitted from a plurality of cells scheduled to perform a cooperative communication, measures the arrival time of each signal, and reports the measured arrival time. Then, the evolved Node B establishes a cooperative communication if the reception time difference is within a time threshold value, and if the reception time difference is greater than the time threshold value, it does not perform the cooperative communication. This function can improve the performance of cooperative communication when the reception time difference between two signals is not longer than a cyclic prefix (CP) in an OFDM communication system. However, when the reception time difference is longer than the cyclic prefix, the function may be used to prevent the performance from deteriorating.

When an evolved Node B determines to perform a cooperative communication, the evolved Node B transmits a control message needed for establishing a cooperative communication to a cooperating cell or the user equipment in step S205, and determines to perform the cooperative communication. When the signal intensity is within a cooperation zone, the cooperating cell performs the cooperative communication function. The cooperative communication function includes reception and transmission or relaying of signals transmitted from the evolved Node B through a control channel and a data channel and includes reception and transmission or relaying of signals transmitted from the user equipment through a control channel and a data channel. A cooperative communication establishment message includes at least one among identification information of the user equipment involving in the transmission/reception of signals through a radio channel, data routing information, scheduling information, Hybrid Automatic Retransmit Request (HARM) information, power information, reference signal information, scrambling information, hopping information, antenna information, modulation information, radio resource position information, transmission time information, and channel coding information. When the user equipment is in motion or the signal intensity is changed and thus a handover condition is fulfilled, the user equipment is handed over to a corresponding cell and the cooperative communication brought into a halt.

A cooperating cell may be a cell of a relay station and, herein, there may be a plurality of relay stations. Also, the relay station may be subordinate to an evolved Node B executing a cooperative communication.

Meanwhile, when there are a plurality of relay stations, the relay stations may belong to different evolved Nodes B. For example, when a first relay station performs a cooperative communication with a second relay station, the first relay station may belong to a first evolved Node B while the second relay station belongs to a second evolved Node B.

The data relaying method of a relay station may be an amplify-and-forward method, a decode-and-forward method, or a control procedure of MAC/RLC/PDCP protocol used in Long-Term Evolution (LTE) and LTE-Advanced systems. For the data relaying operation, scheduling information determined by the evolved Node B at a scheduling period is formed as a relay control information and transmitted to the relay station. During downlink transmission, the scheduling information may be delivered to the relay station along with data stored in the evolved Node B. The relay control information may include position information, channel coding information, transmission time information, and HARQ control information of radio resources to be used when the relay station transmits data through the downlink channel. Radio resource information to be received through an uplink channel may use the same information. Control information and data information to be transmitted from the evolved Node B to the relay station are transmitted through one data channel, and they are formed as one data for a plurality of user equipments registered in the relay station.

In performing the cooperative communication, it is desirable to perform transmission through a control channel from one cell only and to perform the cooperative communication for a data channel. The data channel transmission to a user equipment is performed from a plurality of cells. A control message for cooperative communication transmitted through the control channel to make a signal delivered from one cell to the user equipment may include an identifier for indicating the generation of the control channel, which may occupy one bit, and then another cell which has received the identifier transforms the control channel into Physical Downlink Control Channel (PDCCH) and transmits the signal through the PDCCH to the user equipment. Also, when a cell has a structure using a plurality of component carriers, the control message for cooperative communication may further include modulation information for generating a plurality of PDCCHs and information for mapping each PDCCH to each component carrier.

It is desirable that cells involving in cooperative communication are synchronized with each other, e.g., an evolved Node B with an evolved Node B, an evolved Node B with a relay station, or a relay station with a relay station. How to establish the synchronization will be described in detail later.

FIG. 3 is a block view illustrating an evolved Node B performing a cooperative communication in accordance with an embodiment of the present invention. The cooperative communication may be performed under the management of an evolved Node B 301. The evolved Node B performs the cooperative communication for a user equipment by using a plurality of cells. The evolved Node B includes a controller 303 for comparing channel state information for a radio signal with a predetermined threshold value and determining whether to perform a cooperative communication for the user equipment based on a comparison result, and a transmitter 305 for transmitting a control message for cooperative communication to a cooperating cell that is engaged in the cooperative communication. Herein, the channel state information may include measured signal intensity information for the radio signal.

Meanwhile, the controller 303 may prevent collision between handover and cooperative communication by comparing the signal intensity with a handover threshold value.

Also, the controller 303 may determine whether to perform a cooperative communication based on the QoS information of a communication service, time delay threshold value information of the communication service, or reception time value difference information of the user equipment for a signal transmitted from a cooperating cell.

The cell involving in cooperative communication may be a relay station, and the cell may include a plurality of relay stations. For example, the cell may include a first relay station and a second relay station. Herein, the first relay station and the second relay station may be subordinate to different evolved Nodes B.

The control message may be used for establishing the cooperative communication by including at least any one among identification information of the user equipment, data routing information, scheduling information, HARQ information, power information, reference signal information, scrambling information, hopping information, antenna information, modulation information, radio resource position information, transmission time information, and channel coding information.

The cooperative communication may not be performed for a control channel but performed only for a data channel.

The evolved Node B performing the cooperative communication may further include a synchronizer 307 for performing synchronization with the cooperating cell participating in the cooperative communication. The cell involving in the cooperative communication may be a cell of a relay station.

The measured signal intensity in the cooperative communication may be a signal intensity value of a signal received by the user equipment. This case may occur in a downlink. Herein, the measured signal intensity may include identification information for a cell from which the received signal is transmitted.

Also, the measured signal intensity in the cooperative communication may be a signal intensity value of a signal transmitted from the user equipment. In this case, the transmitter 305 transmits uplink reception information for the user equipment to a neighboring cell. Herein, the measured signal intensity may include a signal intensity value of a signal transmitted from the user equipment and measured in the neighboring cell.

In the description on the evolved Nodes B involving in the cooperative communication, what is already described in the above section of the cooperative communication method will be omitted herein.

Hereafter, embodiments of the present invention will be described in detail with reference to the accompanying drawings.

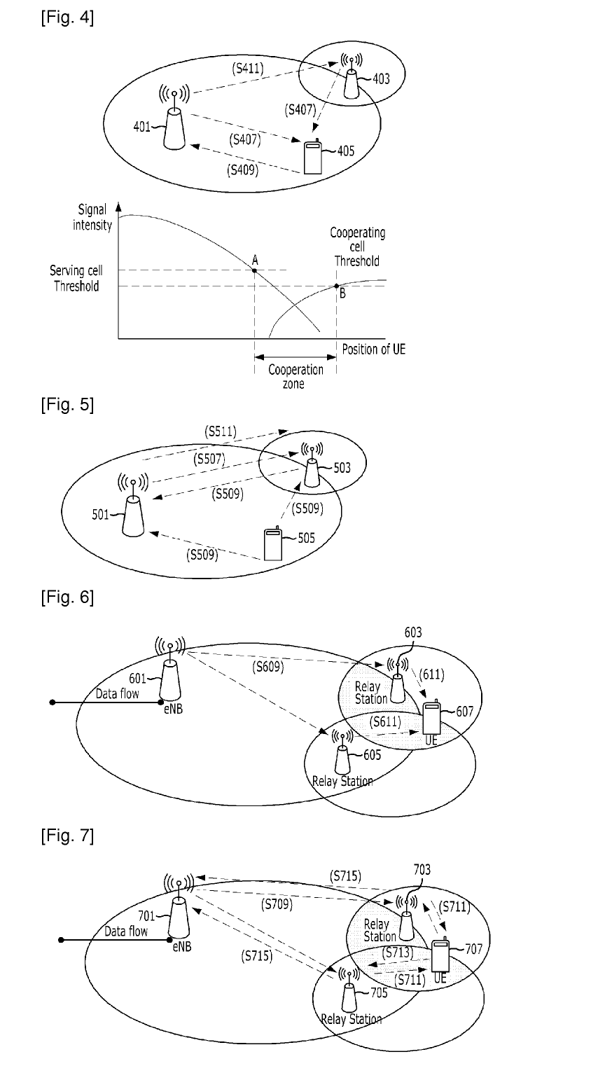

FIG. 4 illustrates how a downlink cooperative communication is established in accordance with an embodiment of the present invention. Referring to FIG. 4, a mobile communication system includes a serving cell 401, a cooperating cell 403, and a user equipment 405. For the sake of convenience in description, the present invention will be explained by taking an example where the serving cell 401 is a cell of an evolved Node B and the cooperating cell 403 is a cell of a relay station.

In step S407, the user equipment 405 receives a radio signal transmitted from the evolved Node B 401 and the relay station 403. Generally, the signal intensity of a radio signal varies according to the cell and the position of the user equipment. The closer the user equipment 405 is positioned to a cell boundary, the lower the signal intensity becomes. In step S409, the user equipment 405 reports the measured signal intensity to the evolved Node B 401. The measured signal intensity may be periodically reported to the evolved Node B 401. The evolved Node B 401 compares the signal intensity and determines whether to perform a cooperative communication or not. When the cooperative communication is needed, the evolved Node B 401 transmits a control message for cooperative communication to the relay station 403 in step S411.

FIG. 4 shows a graph representing the relative position of the user equipment 405 between the evolved Node B 401 and the relay station 403 and the signal intensity thereof. According to the graph of FIG. 4, an A value is a serving cell threshold value, while a B value is a cooperating cell threshold value. When the signal intensities of the signals transmitted from the evolved Node B 401 and the relay station 403 and measured in the user equipment 405 fall between the A value and the B value, cooperative communication is carried out in the cooperation zone where the user equipment 405 is positioned.

This will be described specifically, hereafter.

When the user equipment 405 is positioned in the cell boundary between the evolved Node B 401 and the relay station 403, the user equipment 405 is managed by the evolved Node B 401 for communication in the cell (which is the evolved Node B 401 in FIG. 4) with strong signal intensity, before the cooperative communication begins. The user equipment 405 transmits measured signal intensity information of a received radio signal to the evolved Node B 401. Then, the evolved Node B 401 compares the measured signal intensity information with a predetermined threshold value and determines whether to perform a cooperative communication. Since the cooperative communication establishment process has been described in the above, further description on it will be omitted herein.

Once the cooperative communication is established, the evolved Node B 401 and the relay station 403 perform a cooperative communication for the user equipment 405. When the user equipment 405 is registered in the evolved Node B 401, the evolved Node B 401 directly involves in controlling the cooperative communication. On the other hand, when the user equipment 405 is registered in the relay station 403, the user equipment 405 is handed over from the relay station 403 to the evolved Node B 401 in consideration of the control efficiency of cooperative communication and the cooperative communication is performed. Accordingly, the evolved Node B 401 becomes an end point of General Packet Radio Service (GPRS) Tunneling Protocol (GTP) and the evolved Node B 401 executes assembling and management of Internet Protocol (IP) packets. Since the evolved Node B 401 is in charge of setting up scheduling related information for cooperative communication, the relay station 403 relays data to the user equipment 405 based on the control information determined in the evolved Node B 401.

In downlink, when data arrive at an evolved Node B buffer, the evolved Node B 401 transmits data and a control message for cooperative communication to the relay station 403 after scheduling, and the relay station 403 receives the data and the control message for cooperative communication from the evolved Node B 401 by using its cooperative communication function. The evolved Node B 401 and the relay station 403 simultaneously transmit the data to the user equipment 405 for cooperative communication so that the user equipment 405 simultaneously receives the data both from the evolved Node B 401 and the relay station 403. For temporal dispersion, it is possible for the user equipment 405 to receive the data transmitted from the evolved Node B 401 when the evolved Node B 401 transmits the data to the relay station 403 and then to receive the data transmitted from the relay station 403.

According to an exemplary embodiment of the present invention, the data and the control message for cooperative communication may be transmitted through the following process. The user equipment 405 measures downlink channel state and report downlink channel information to the evolved Node B 401. The evolved Node B 401 receives the downlink channel state information from the user equipment 405 and makes an estimation on the channel state. Herein, the channel state may be downlink radio channel state of evolved Node B-to-user equipment or relay station-to-user equipment and the channel state information is obtained by the user equipment 405 receives data transmitted through a downlink channel from the evolved Node B 401 and the relay station 403 and measuring the channel state. The evolved Node B 401 determines control message information that can maximize the reception performance of the user equipment 405 in consideration of the states of a plurality of radio channels, and it generates a control message by additionally taking the QoS information of data into consideration.

A control message includes scheduling information (e.g., modulation information, HARQ information, power information and so forth) to be used for the relay station 403 to transmit data to the user equipment 405. The control message may include transmission time information. The transmission time information is needed for the relay station 403 to transmit data to the user equipment 405 at the same time when the evolved Node B 401 transmits data to the user equipment 405. It is desirable and effective to form a control channel through which a cell (which is the evolved Node B 401 or the relay station 403) transmits signals to the user equipment 405 for cooperative communication to transmit signals only from the cell, i.e., either from the evolved Node B 401 or from relay station 403, and to form a data channel capable of supporting the cooperative communication between the evolved Node B 401 and the relay station 403. Therefore, the data channel may simultaneously transmit signals from the evolved Node B 401 and signals from the relay station 403, while the control channel may include an identifier (which may occupy one bit) for directing generation of a control channel in a control message and transmit the control message so that only one cell (which may be the cell of the evolved Node B 401 or the cell of the relay station 403) is in charge of transmitting signals. Another cell that has received the identifier for directing it to generate a control channel transforms the control channel into a physical downlink control channel (PDCCH) and transmits signals to the user equipment 405 through the physical downlink control channel (PDCCH). Also, when the cell has a structure in which a plurality of component carriers are used, modulation information for generating a plurality of physical downlink control channels (PDCCHs) and information for mapping the physical downlink control channels (PDCCHs) to the component carriers, respectively, are added to the control message and transmitted.

When signals are transmitted through a link of evolved Node B-to-relay station, the evolved Node B 401 may store data to be transmitted for cooperative communication and a control message for cooperative communication together, and may store a control message and data to be transmitted to a plurality of user equipments 405 in one transmission channel. A control message, or control information or header for representing data structure information is used to allow the relay station 403 to analyze the stored information. The data to be transmitted in cooperative communication are formed into transport blocks (TBs) in the evolved Node B 401 and then modulated. Particularly, the evolved Node B 401 forms transport blocks appropriate for a determined modulation method and the data of the transport blocks may use a structure including protocol headers after the completion of the upper layer procedures of Media Access Control/RLC/Packet Data Convergence Protocol (MAC/RLC/PDCP).

To increase the scheduling efficiency, the downlink channel state measured by the user equipment 405 may be directly transmitted to the evolved Node B 401, or it may bed relayed by the relay station 403 to the evolved Node B 401.

The HARQ retransmission operation between the user equipment 405 and the relay station 403 may be controlled directly by the relay station 403 or by the evolved Node B 401. In the HARQ retransmission operation, a retransmission request message, which is an acknowledgement (ACK) message or a non-acknowledgement (NACK) message, and retransmission data, which are transmitted through a physical downlink control channel (PDCCH) and a physical downlink shared channel (PDSCH), may use the cooperative communication as well. When data are retransmitted, the data stored in the relay station 403 are used as many as possible, and thus, when the evolved Node B 401 receives a retransmission request, only retransmission control information can be transmitted to the relay station 403.

According to an embodiment of the present invention, first, the evolved Node B 401 transmits data and a control message for cooperative communication to the relay station 403. When the relay station 403 normally receives the data, it transmits an ACK message to the evolved Node B 401. When the relay station 403 fails to receive the data, it transmits a NACK message and waits for the retransmission of the data. When the relay station 403 normally receives the data, the relay station 403 and the evolved Node B 401 simultaneously transmit the data to one user equipment 405. However, signal transmission through the physical downlink control channel (PDCCH) can be performed only in one cell, which is either the evolved Node B 401 or the relay station 403. When the user equipment 405 normally receives the data, it transmits an ACK message. When it fails to receive the data, it transmits a NACK message. When the evolved Node B 401 receives the NACK message, the evolved Node B 401 and the relay station 403 retransmit the data in cooperative communication. When the evolved Node B 401 does not directly receive the NACK message, the relay station 403 may relay the NACK message to the evolved Node B 401. When the user equipment 405 is positioned close to the evolved Node B 401, the retransmission operation of an evolved Node B-to-user equipment link is maximally performed and the retransmission operation of a relay station-to-user equipment link is not performed. Also, when the user equipment 405 is positioned close to the relay station 403, the retransmission operation of a relay station-to-user equipment link is maximally performed and the retransmission operation of an evolved Node B-to-user equipment link is not performed.

The type of retransmission operation is selected in the evolved Node B 401 according to the position of the user equipment 405, and the determined retransmission type information is marked with an identifier and informed to the relay station 403 or the user equipment 405 and communication is performed according to the determined operation type. Radio resource information needed for the retransmission from the relay station 403 are included in cooperative communication information and transmitted when the evolved Node B 401 transmits the data to the relay station 403. In a case where the relay station 403 already includes the data, the evolved Node B 401 transmits only the control information.

When the relay station 403 performs retransmission to increase the signal reception performance of the user equipment 405, it may modulate the data in the same transmission data type as those of the evolved Node B 401 and the relay station 403, transmit the data in conformity to the retransmission type, or transmit the data in the same way as the initial transmission. The setup of the data type may be marked when the evolved Node B 401 transmits the control message and transmitted.

Also, to reduce the complexity needed for the transmission of the control message, the evolved Node B 401 may not transmit control information to the relay station 403 but transmit the control information based on the same type as that of the initial transmission and radio resource information.

When the user equipment 405 receives data transmitted from the evolved Node B 401 and the relay station 403 at different time points, the user equipment 405 receives downlink channel demodulation information for the two cells in the initial period of cooperative communication and configures the modulation information. When the evolved Node B 401 and the relay station 403 transmit data, they modulate signals to be transmitted through a control channel and transmit the modulated signals and transmit data through a data channel based on the modulation method used by the evolved Node B 401 and the relay station 403 and a cell-radio network temporary identifier (C-RNTI) of the user equipment 405 configured by the evolved Node B 401 and the relay station 403. The user equipment 405 demodulates the signals transmitted through the control channel by using a plurality of C-RNTIs and after it demodulates each control channel, it receives data from a plurality of data channels.

FIG. 5 illustrates how an uplink cooperative communication is established in accordance with an embodiment of the present invention. Referring to FIG. 5, a mobile communication system includes a servicing cell 501, a cooperating cell 503, and a user equipment 505. For the sake of convenience in description, the servicing cell 501 will be referred to as an evolved Node B 501, and the cooperating cell 503 as a relay station 503.

In step S509, the user equipment 505 transmits an uplink signal. The uplink signal may be received not only by the evolved Node B 501, which is the cell in which the user equipment 505 is registered, but also the relay station 503 as well. The evolved Node B 501 and the relay station 503 that have received the uplink signals transmitted form the user equipment 505 measure the signal intensity or quality of the received uplink signal, individually. When the signal intensity of the uplink signal measured by the evolved Node B 501 is lower than a predetermined threshold value and a condition for handover is not satisfied, the evolved Node B 501 determines to perform cooperative communication for the user equipment 505. Additionally, the signal intensity of the uplink signal measured by the relay station 503 may be used to determine whether to perform cooperative communication or not. In this case, the relay station 503 transmits measured signal intensity information of the uplink signal to the evolved Node B 501, which also occurs in the step S509.

Meanwhile, in step S507, the evolved Node B 501 may transmit uplink reception information of the user equipment 505 to a neighboring cell, which is the cell of the relay station 503, so that the neighboring cell 503 could easily measure the uplink signal transmitted from the user equipment 505. Herein, the uplink reception information may include identification information of the user equipment 505, physical layer setup information and the like.

When it is determined based on the measured signal intensity of the uplink signal that cooperative communication should be performed, the evolved Node B 501 transmits a control message for cooperative communication to the relay station 503 in step S511. The relay station 503 is set up to initiate cooperative communication based on the control message. In the mean time, the control message for cooperative communication may be transmitted to the user equipment 505.

When it is difficult to measure a channel state based on an uplink data channel, the user equipment 505 transmits signals through a random access channel. Then, a plurality of cells receive the signals and measures the signal intensity and time information. The measured information is transmitted to the evolved Node B 501 and the evolved Node B 501 determines whether a condition for cooperative communication is satisfied or not. When it is determined that cooperative communication is needed, the cooperative communication may begin.

This process will be described in detail, hereafter.

An uplink transmits transmission permission information of the user equipment 505 scheduled in the evolved Node B 501 to the relay station 503 based on the configuration of the mobile communication system. In particular, a control message may include reception time information, which may be needed for a cooperating cell to receive data from the user equipment 505 at the same time when the evolved Node B 501 receives the data.

It is desirable and effective to make only one cell, either the evolved Node B 501 or the relay station 503, transmit signals through a control channel to the user equipment 505. To make only one cell transmit signals through a control channel, the signals transmitted through the control channel include an identifier (which may be a one-bit identifier) for directing generation of a physical downlink control channel (PDCCH), which is a control channel. Then, a cell that has received the signals with the identifier transforms a control channel into a physical downlink control channel (PDCCH) and transmits signals to the user equipment 505 through the physical downlink control channel (PDCCH). Also, when the mobile communication system has a configuration that a cell uses a plurality of component carriers, modulation information for generating a plurality of physical downlink control channels (PDCCHs) and mapping information for mapping the physical downlink control channels (PDCCHs) to the component carriers, respectively, are added to a control message and then the control message including the informations is transmitted.

When the relay station 503 receives the transmission permission information of the user equipment 505, it may transmit the transmission permission information to the user equipment 505. When the user equipment 505 is positioned close to the evolved Node B 501, the user equipment 505 may directly receive the transmission permission information transmitted through the control channel from the evolved Node B 501. The user equipment 505 receives data of an uplink buffer based on the transmission permission information transmitted through the control channel from the evolved Node B 501 or the relay station 503, and the evolved Node B 501 and the relay station 503 simultaneously receive the data. The relay station 503 relays the received data to the evolved Node B 501, and the evolved Node B 501 may transmit the data it has received directly from the user equipment 505 to a gateway or it may combine the data it has received with data received from the relay station 503 to thereby produce combined data and transmit the combined data to the gateway.

Hereafter, an exemplary embodiment where the relay station 503 demodulates the data transmitted from the user equipment 505 and transmits the demodulated data to the evolved Node B 501 will be described.

The relay station 503 receives signals transmitted through an uplink channel from the user equipment 505 by using a control message transmitted from the evolved Node B 501.

The relay station 503 demodulates the signals received through the uplink channel, performs cyclic redundancy check (CRC) onto the signals, and transmits successfully demodulated data to the evolved Node B 501. The relay station 503 does not transmit data that are not successfully demodulated, and reports a demodulation failure result to the evolved Node B 501. The demodulation failure result is used for the evolved Node B 501 to determine whether to perform a cooperative communication or not. To be specific, when the relay station 503 reports the demodulation failure result to the evolved Node B 501, the evolved Node B 501 counts the number of failures and it may stop the cooperative communication. When there are a plurality of component carriers and only some of them are successfully demodulated, the data of the successfully demodulated carriers and information on carriers that are not successfully demodulated are relayed.

An HARQ retransmission procedure may occur between the evolved Node B 501 and the relay station 503 and between the relay station 503 and the user equipment 505. It may occur between the evolved Node B 501 and the user equipment 505 as well. When data transmitted from the user equipment 505 are erroneously received, the evolved Node B 501 receives the data from the relay station 503, performs a demodulation operation. When an error occurs even after the demodulation, it may perform the retransmission operation gain.

Hereafter, a retransmission procedure will be described in accordance with an exemplary embodiment of the present invention.

When the evolved Node B 501 normally receives data transmitted from the user equipment 505, the evolved Node B 501 transmits an ACK message to the user equipment 505 and when if fails to receive the data, it transmits a NACK message. When both evolved Node B 501 and relay station 503 can simultaneously transmit an ACK/NACK message to the user equipment 505, retransmission procedures of an evolved Node B-to-user equipment link and a relay station-to-user equipment 505 link may be performed together. When they cannot transmit an ACK/NACK message simultaneously, only a retransmission procedure of one link is performed. When the user equipment 505 is positioned close to the evolved Node B 501, a retransmission procedure of the evolved Node B-to-user equipment link is performed maximally, while a retransmission procedure of the relay station-to-user equipment link is not performed. When the user equipment 505 is positioned close to the relay station 503, the retransmission procedure of the relay station-to-user equipment link is performed maximally, while the retransmission procedure of the evolved Node B-to-user equipment link is not performed. The uplink data transmitted from the user equipment 505 to the relay station 503 are relayed to the evolved Node B 501, and the radio resource information for the relaying may be determined directly by the relay station 503 or it may be determined by the evolved Node B 501 and reported to the relay station 503. The relay information may be transmitted from the evolved Node B 501 to the relay station 503 together with the transmission of the initial transmission permission information. To reduce the complexity in transmission of a control message, the evolved Node B 501 may not transmit the control message to the relay station 503 and the relay station 503 may transmit data by using the same data type and radio resource information used when the user equipment 505 made an initial transmission to the evolved Node B 501.

The data relayed from the relay station 503 to the evolved Node B 501 may be transmitted at the same time when the user equipment 505 transmits data to the evolved Node B 501. For this synchronization operation, the evolved Node B 501 may designate relay transmission time information and a data modulation form and transmit them to the relay station 503.

FIG. 6 illustrates a process of performing a downlink cooperative communication by using a plurality of relay stations in accordance with an embodiment of the present invention. Referring to FIG. 6, the mobile communication system includes an evolved Node B 601, a first relay station 603, a second relay station 605, and a user equipment 607.

When the user equipment 607 is positioned in the boundary of the cell of the evolved Node B 601, the cell of the first relay station 603 and the cell of the second relay station 605, the user equipment 607 operates under the control of the evolved Node B 601. The evolved Node B 601 determines whether to perform a cooperative communication according to cooperative communication conditions. Since a cooperative communication is performed using a plurality of relay stations 603 and 605 in this embodiment of the present invention, the user equipment 607 receives radio signals transmitted from the first relay station 603 and the second relay station 605 and measures the signal intensities of the received radio signals. The measured signal intensity information may be directly reported to the evolved Node B 601, or it may be reported to the evolved Node B 601 through the first relay station 603 and the second relay station 605. The evolved Node B 601 compares the measured signal intensities with a predetermined threshold value and determines whether to perform a cooperative communication or not. Since the method for establishing a cooperative communication has been described in detail with reference to FIG. 4, it will not be described again herein. Once it is determined to perform a cooperative communication, the evolved Node B 601 transmits a cooperative communication setup message to the relay stations 603 and 605. Accordingly, the first relay station 603 and the second relay station 605 perform a cooperative communication for the user equipment 607 and the evolved Node B 601 is in charge of the overall cooperative communication. When the user equipment 607 is registered in the evolved Node B 601, the evolved Node B 601 directly controls the cooperative communication. When the user equipment 607 is registered in the first relay station 603, the control efficiency of cooperative communication is taken into consideration along with the signal intensity and the user equipment 607 is handed over from the first relay station 603 to the evolved Node B 601 and the cooperative communication is performed. Accordingly, the evolved Node B 601 becomes an end point of a GTP tunneling and the evolved Node B 601 assembles and manages IP packets. Since scheduling information including a control message is established under the control of the evolved Node B 601, the first relay station 603 and the second relay station 605 perform a function of relaying the scheduling information established in the evolved Node B 601 to the user equipment 607.

A downlink transmits data and scheduling control information to the first relay station 603 and the second relay station 605 at a scheduling period, which is one subframe, when the data have arrived in a buffer of the evolved Node B 601, and the first relay station 603 and the second relay station 605 receive the data and the scheduling information by using a cooperative communication function in step S609. In step S611, the first relay station 603 and the second relay station 605 relay the data and the scheduling control information to the user equipment 607. To efficiently transmit data from the evolved Node B 601, one data is transmitted and identification information that the relay stations 603 and 605 can receive is marked in the control information for demodulating the data so that only one radio resource should be used. As for the identification information, an RNTI for cooperative communication may be designated in a physical downlink control channel (PDCCH) and used, or the identification information may be marked to be multicast information transmitted to a plurality of cells, which are the cells of the first relay station 603 and the second relay station 605, in a field of a control channel. The multiple relay stations 603 and 605 simultaneously transmit the data to the user equipment 607 so that the user equipment 607 could receive the signals from the first relay station 603 and the signals from the second relay station 605 at the same time.

The user equipment 607 can directly receive signals transmitted from the evolved Node B 601 through a control channel according to where the user equipment 607 is positioned. Thus, it is possible for the evolved Node B 601 to participate in a cooperative communication when the relay stations 603 and 605 relay the signals. To increase the scheduling efficiency, the downlink channel state measured by the user equipment 607 may be directly transmitted to the evolved Node B 601 or it may be transferred to the evolved Node B 601 after being relayed by the multiple relay stations 603 and 605. The HARQ retransmission operation of the user equipment 607 and the relay stations 603 and 605 may be directly controlled by the relay stations 603 and 605, or it may be controlled by the evolved Node B 601. The retransmission operations of the relay stations 604 and 605 are performed independently from each other, and when the user equipment 607 makes a request for retransmission, the data stored in the multiple relay stations 603 and 605 are retransmitted. The specific retransmission operation is the same as the retransmission procedure between the evolved Node B 601 and the relay stations 603 and 605, and the only difference is that the number of the relay stations is plural.

FIG. 7 illustrates a process of performing an uplink cooperative communication by using a plurality of relay stations in a mobile communication system in accordance with an embodiment of the present invention. Referring to FIG. 7, the mobile communication system includes an evolved Node B 701, a first relay station 703, a second relay station 705, and a user equipment 707.

A cooperative communication is established as the evolved Node B 701, or the first relay station 703 and the second relay station 705 receives an uplink signal transmitted from the user equipment 707 and measures the signal intensity of the uplink signal. When the first relay station 703 and the second relay station 705 receives the uplink signal, measured signal intensity information obtained in the first relay station 703 and the second relay station 705 is relayed to the evolved Node B 701. The evolved Node B 701 compares the received signal intensity informations with a predetermined threshold value and determines whether to perform a cooperative communication or not.

An uplink transmits transmission permission information of the user equipment 707 from the evolved Node B 701 through a control channel, or transforms transmission permission information into control information and transmits the control information to the first relay station 703 and the second relay station 705 according to the configuration of a mobile communication system in step S709. The multiple relay stations 703 and 705 relay the transmission permission information to the user equipment 707 in step S711. Also, the user equipment 707 may directly receive signals transmitted through the control channel from the evolved Node B 701 according to the position of the user equipment 707. The user equipment 707 transmits data of an uplink buffer according to a control channel and the evolved Node B 701 and the relay stations 703 and 705 may simultaneously receive the data in step S711. In step S715, the multiple relay stations 703 and 705 relay the received data to the evolved Node B 701, and the evolved Node B 701 combines the data transmitted from the relay stations 703 and 705, demodulates the combined data and transmits the demodulated data to a gateway.

An HARQ retransmission procedure may be performed between the evolved Node B 701 and the multiple relay stations 703 and 705 and between the multiple relay stations 703 and 705 and the user equipment 707. When the relay stations 703 and 705 normally receive data from the user equipment 707, they instantly transmit the data to the evolved Node B 701. It is effective for the user equipment 707 to perform a retransmission only when all of the relay stations 703 and 705 and the evolved Node B 701 that have participated in cooperative communication make a request for retransmission. When the evolved Node B 701 successfully demodulates the data, it transmits the demodulated data to a gateway immediately. Specific retransmission operation is the same as the retransmission performed in the evolved Node B 701 and the multiple relay stations 703 and 705, and the only difference is that the number of the relay stations is plural.

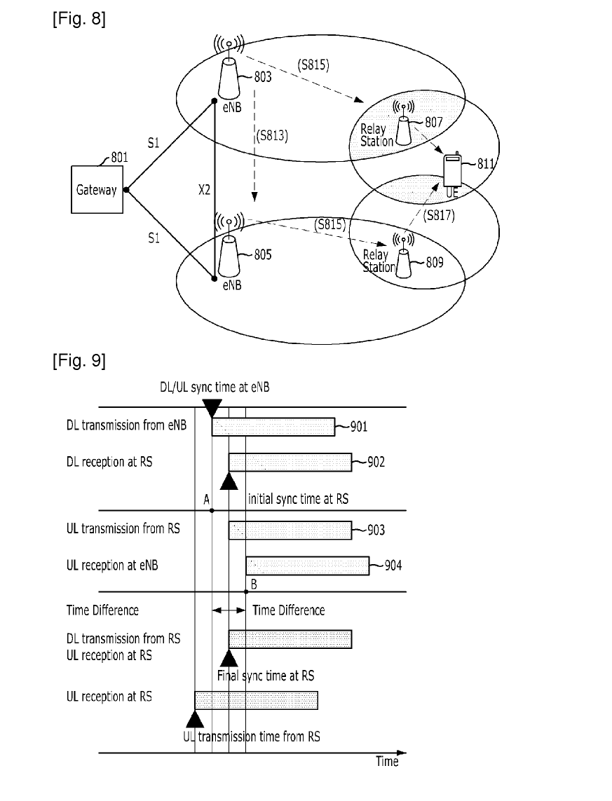

FIG. 8 illustrates a process of performing a cooperative communication by using a plurality of relay stations belonging to different evolved Nodes B in a mobile communication system in accordance with an embodiment of the present invention. Referring to FIG. 8, the mobile communication system includes a gateway 801, a first evolved Node B 803, a second evolved Node B 805, a first relay station 807 belonging to the first evolved Node B 803, a second relay station 809 belonging to the second evolved Node B 805, and a user equipment 811.

When the user equipment 811 is positioned in the cell boundary between the first relay station 807 and the second relay station 809, the user equipment 811 operates under the control of an evolved Node B. However, in a system where relay stations are linked to different evolved Nodes B, signals are transmitted/received based on scheduling information determined by the first evolved Node B 803 to which the user equipment 811 belongs.

In downlink, the user equipment 811 receives radio signals from the first relay station 807 and the second relay station 809, measures their signal intensity, and reports measured signal intensity informations to the first evolved Node B 803. Of course, the user equipment 811 may measure the signal intensities of radio signals transmitted from the first evolved Node B 803 and the second evolved Node B 805 and report the measured signal intensities. When the user equipment 811 reports the measured signal intensity informations to the first relay station 807 and the second relay station 809, the first relay station 807 and the second relay station 809 relay the measured signal intensity informations to the first evolved Node B 803. In case of the second relay station 809, the measured signal intensity information may be reported to the first evolved Node B 803 through the second evolved Node B 805.

In uplink, the first relay station 807 and the second relay station 809 receive radio signals transmitted from the user equipment 811, measure the signal intensities of the radio signals, and report measured signal intensity informations to the first evolved Node B 803. In case of the second relay station 809, the measured signal intensity information may be reported to the first evolved Node B 803 through the second evolved Node B 805. Of course, the first evolved Node B 803 and the second evolved Node B 805 may receive radio signals transmitted from the user equipment 811 and measure signal intensities of the radio signals.

The measured signal intensity informations are combined and compared with a predetermined threshold value, and whether to perform a cooperative communication is determined based on the comparison result.

When it is determined to perform a cooperative communication, the first relay station 807 and the second relay station 809 perform a cooperative communication for the user equipment 811, and the first evolved Node B 803 takes charge of controlling the cooperative communication. In step S813, the first evolved Node B 803 in charge of scheduling establishes a cooperative communication environment by transmitting a control message for cooperative communication to the second evolved Node B 805 and the second relay station 809 that are supposed to participate in the cooperative communication. When the user equipment 811 is registered in the first evolved Node B 803, the first evolved Node B 803 directly controls the cooperative communication. When the user equipment 811 is registered in the first relay station 807, the user equipment 811 is handed over from the first relay station 807 to the first evolved Node B 803 and a cooperative communication process is performed in consideration of control efficiency as well as signal intensity. Accordingly, the first evolved Node B 803 becomes an end point of GTP tunneling, and the first evolved Node B 803 performs not only the scheduling but also assembling and management of IP packets as well.

In downlink, a gateway transmits scheduling information and data of a downlink buffer to the first evolved Node B 803, and the first evolved Node B 803 relays scheduling control information and data to the first relay station 807 in step S815. In steps S813 and S815, the first evolved Node B 803 also transmits the same information to the second evolved Node B 805 and the second relay station 809. In step S817, the first relay station 807 and the second relay station 809 simultaneously transmit the data to the user equipment 811 based on the scheduling information.

An HARQ operation may be performed between the user equipment 811 and the first and second evolved Nodes B 803 and 805 and between the user equipment 811 and the first and second relay stations 807 and 809. The uplink uses the same structure as that of the downlink and operates in reverse to the route described in the above. The scheduling information is determined by the gateway and relayed to an evolved Node B and a gateway and transmitted to the user equipment 811.

FIG. 9 illustrates a synchronization process between an evolved Node B and a relay station in accordance with an embodiment of the present invention. In this specification, wireless link includes a connection between an evolved Node B and a relay station and a connection between a relay station and a user equipment. Since the radio channel between the evolved Node B and the relay station is a route through which a great deal of data and control information are transmitted, the channel state of the radio channel should be maintained very stably to efficiently operate a cooperative communication and a relay function.

In particular, the control information transmitted from the evolved Node B to the relay station may include scheduling information and retransmission control information, and it should be transmitted through a data channel. However, the control information should be transmitted more stably than general data. This method may be used to transmit data with a high priority order among traffic data.

In order to effectively realize the cooperative communication disclosed in this specification, it is required to develop a method for stably transmitting/receiving control information between the evolved Node B and the relay station. Among such methods are channel coding the control information to be transmitted from the evolved Node B to the relay station, adaptive modulation, or setting up a system to transmit data at a lower error rate during power allocation. When the control information is transmitted after being modulated, the control information may be transmitted through a data channel, e.g., physical downlink shared channel (PDSCH), through which general data are transmitted. In this case, modulation information of data to be transmitted to one data channel may become different according to general data and control information. In order to simplify a demodulation function in an upper layer, there is a method of separating a channel for transmitting general data from a channel for transmitting control information and independently modulating the channels. One channel is distinguished from the other channel by assigning and using an RNTI for control information to demodulate the control channel, or by transmitting signals through a plurality of data channels while using the general RNTI.

To stably transmit/receive control information between the evolved Node B and the relay station, the evolved Node B and the relay station may operate while maintaining temporal synchronization. Radio resources used for the evolved Node B and the relay station to transmit signals are transmitted at the same time, and physical channel transmission time, such as control channel and data channel, is also maintained the same.

The following two-step process may be used to establish temporal synchronization between the relay station and the evolved Node B.

In a primary synchronization step, in step S901, the evolved Node B transmits a downlink sync signal to the relay station. In step S902, the relay station receives the downlink sync signal broadcasted by the evolved Node B and determines the relay initial sync time based on the received sync signal. Herein, since the established initial synchronization includes a propagation time delay value according to the range between the evolved Node B and the relay station, the established initial synchronization is not an exact value but a rough value, and the relay station uses the initial synchronization value as an initial synchronization time between the uplink and the downlink.

In a secondary synchronization step, the relay station performs a random access procedure to exactly establish synchronization with the evolved Node B. In step S903, The relay station uses uplink random access radio resources of the evolved Node B to transmit signals or random access preamble through a random access channel. The transmission time is based on the initial synchronization time. In step S904, the evolved Node B receives the signals or the random access preamble transmitted through the random access channel. The evolved Node B transmits response information corresponding to the signals received through the random access channel to the relay station. The response information includes a time difference value between the sync time transmission time (A) of the evolved Node B and the random access channel time (B). The relay station establishes the final relay synchronization time based on the time difference value information, and establishes an exact synchronization between the uplink and the downlink in consideration of the random access channel transmission time and the time difference value information received from the evolved Node B.

To be more specific, the synchronization between the uplink and the downlink in the relay station is established by considering only a half the time difference value transmitted from the evolved Node B (e.g., random access channel transmission time in the relay station ? time difference value/2)=synchronization time in the relay station). This method contributes to coincide the downlink transmission time and uplink reception time between the evolved Node B and the relay station.

The uplink transmission time of the relay station is established considering the time difference value determined by the evolved Node B (e.g., random access channel transmission time in the relay station ? time difference value=uplink transmission time in the relay station). The uplink transmission time of the relay station is for making the signals transmitted from the relay station through the uplink channel arrive at the uplink reception time of the evolved Node B.

The relay station operates in two states, which are an initial access state and a relay access state, according to the state of link to the evolved Node B. The initial access state is a state where the relay station is not linked to the evolved Node B and the temporal synchronization between the evolved Node B and the relay station is not established. The relay station uses a sync channel and a system information broadcasting channel for transmitting signals from the evolved Node B to a user equipment in order to be connected to the evolved Node B in the initial access state. The relay station may temporally receive downlink channels of all subframes transmitted from the evolved Node B. When the relay station acquires downlink frequency and synchronization, the evolved Node B receives broadcasted sync signals and acquires downlink synchronization. This procedure corresponds to the operation of the aforementioned primary synchronization step. Since the user equipment uses the same method as the procedure for acquiring downlink synchronization in the evolved Node B and the evolved Node B does not additionally transmit any initial transmission signals for the relay station, it is advantageous in that the consumed amount of radio resources is reduced and the synchronization procedure performed in the relay station is simplified. After the relay station acquires the downlink synchronization of the evolved Node B, it receives broadcasting information transmitted from the evolved Node B to the user equipment and acquires system information of the evolved Node B. The broadcasting information may be transmitted through a physical broadcasting channel (PBCH) from the evolved Node B. In order to additionally receive specific evolved Node B system information and uplink information of the evolved Node B, the relay station may use a method of receiving system information block transmitted through a physical downlink shared channel (PDSCH), which is a data channel.

The relay access state is a state where the relay station is linked with the evolved Node B and exact temporal synchronization is established between the evolved Node B and the relay station. The synchronization procedure is the same as the aforementioned secondary synchronization step. In the relay access state where the synchronization procedure completed, the relay station uses only the radio resources of temporally designated when it communicates with the evolved Node B. System information is transmitted from the evolved Node B to the relay station by using radio resources inside a designated subframe, and the relay station receives the system information from the subframe. Control information transmitted from the relay station to the evolved Node B is also transmitted using the same method and radio resources inside a designated subframe.

As described above, the evolved Node B determines designation of for a link between the evolved Node B to the relay station and radio resource configuration information. The evolved Node B transmits determined time information to the relay station and the user equipment. To facilitate the transmission of system information or control information between the evolved Node B and the relay station, it is possible to separately form a transmission channel and a reception channel for transmitting system information and control information in a fixed position within a designated subframe. The synchronization management and radio state management of a link in the relay access state is performed by transmitting reference signals using the radio resources within the designated subframe. When the radio channel state is deteriorated drastically and thus the relay station fails to maintain synchronization, the relay station shifts its state into the initial access state and receives all subframes to perform the procedure of re-acquiring sync signals from the evolved Node B. Also, the relay station may maximally maintain its relaying function by receiving subframes that are essential for the acquisition of synchronization. For example, the relay station stops transmitting sync signal transmission subframes and receives signals of the evolved Node B so that only the sync signals transmitted from the evolved Node B could be searched for.

The radio resources of a random access channel transmitted from the relay station to the evolved Node B may be divided based on whether the relay station is in the initial access state or the relay access state. In the initial access state, the relay station transmits signals through the random access channel by using the same random access channel resources used by the user equipment among the uplink resources of the evolved Node B. In the relay access state, the relay station may transmit signals by using random access channel resources positioned within a subframe designated as an evolved Node B-to-relay station link among the uplink resources of the evolved Node B. In this case, the random access channel resources are those transmitted by being delayed one to two symbols on a time axis and having a size ended one to two symbols before in comparison with the random access channel resources used by the user equipment. This structure prevents the radio signals transmitted form the relay station to the evolved Node B from being overlapped with the radio signals transmitted from the user equipment to the relay station.

The method of the present invention described above may be realized as a program and stored in a computer-readable recording medium such as CD-ROM, RAM, ROM, floppy disks, hard disks, magnetooptical disks and so forth. Since this process can be easily implemented by those skilled in the art to which the present invention pertains, further description on it will not be provided herein.

The present application contains subject matters related to Korean Patent Application Nos. 10-2008-0094192, 10-2009-0018414, and 10-2009-0055829, filed with the Korean Intellectual Property Office on Sep. 25, 2008, Mar. 4, 2009, and Jun. 23, 2009, respectively, the entire contents of which are incorporated herein by reference in their entirety.

While the present invention has been described with respect to the specific embodiments, it will be apparent to those skilled in the art that various changes and modifications may be made without departing from the spirit and scope of the invention as defined in the following claims.

1. A method for performing a cooperative communication for a user equipment by using a plurality of cells, comprising:
comparing channel state information for a radio signal with a predetermined threshold value to thereby produce a comparison result;
determining whether to perform the cooperative communication for the user equipment based on the comparison result; and
transmitting a control message for cooperative communication to a cooperating cell which is to perform the cooperative communication.

2. The method of claim 1, wherein the channel state information includes information of measured signal intensity for the radio signal.

3. The method of claim 2, wherein said comparing channel state information for a radio signal with a predetermined threshold value includes:
comparing the measured signal intensity with a handover threshold value.

4. The method of claim 2, wherein said determining whether to perform the cooperative communication for the user equipment includes:
determining whether to perform the cooperative communication based on quality of service (QoS) information of a communication service, time delay threshold value information of the communication service, or information on reception time difference of the user equipment for the signal transmitted from the cooperating cell.

5. The method of claim 2, wherein the control message includes at least one selected from the group consisting of identifier information of the user equipment, data routing information, scheduling information, HARQ information, power information, reference symbol information, scrambling information, hopping information, antenna information, modulation information, radio resource position information, transmission time information, and channel coding information.

6. The method of claim 2, wherein the cooperating cell is a relay station.

7. The method of claim 6, wherein the relay station includes a first relay station and a second relay station.

8. The method of claim 7, wherein the first relay station and the second relay station belong to different evolved Nodes B.

9. The method of claim 2, wherein the cooperative communication is performed only onto data channel.

10. The method of claim 2, further comprising:
establishing synchronization with the cooperating cell.

11. The method of claim 10, wherein the cooperating cell is a cell of a relay station.

12. The method of claim 2, wherein the measured signal intensity is a signal intensity of a signal received by the user equipment.

13. The method of claim 12, wherein the measured signal intensity includes identification information for a cell transmitting the received signal.

14. The method of claim 2, wherein the measured signal intensity is a signal intensity of a signal transmitted from the user equipment.

15. The method of claim 14, further comprising:
transmitting uplink reception information for the user equipment to a neighboring cell,
wherein the measured signal intensity includes a signal intensity of the signal transmitted from the user equipment and measured by the neighboring cell.

16. An evolved Node B for performing a cooperative communication for a user equipment by using a plurality of cells, comprising:
a controller configured to compare channel state information for a radio signal with a predetermined threshold value to thereby produce a comparison result and determine whether to perform the cooperative communication for the user equipment based on the comparison result; and
a transmitter configured to transmit a control message for cooperative communication to a cooperating cell which is to perform the cooperative communication.
